(19) United States
(12) Patent Application Publication
(10) Pub. No.: US 2025/0121330 A1
(43) Pub. Date: Apr. 17, 2025

(54) FILTRATION MEMBRANE MODULE

(71) Applicant: BLUE FOOT MEMBRANES NV, Lommel (BE)

(72) Inventors: Peter AERTS, Lommel (BE); Ulrich BRÜSS, Lommel (BE); Udo MYLER, Lommel (BE); Stephan VAN HOOF, Lommel (BE)

(21) Appl. No.: 18/703,846

(22) PCT Filed: Oct. 28, 2022
(86) PCT No.: PCT/EP2022/080202

§ 371 Date: Apr. 23, 2024

(30) Foreign Application Priority Data
Oct. 29, 2021 (BE) BE2021/5847

(51) Int. Cl. B01D 63/08; B01D 65/02; C02F 1/44

(52) U.S. Cl. CPC B01D 63/082; B01D 65/02; C02F 1/44; B01D 2313/14; B01D 2321/04; C02F 2303/16

(57) ABSTRACT

The current invention relates to a filtration module for the purification and/or filtering of a fluid such as water or wastewater: said module comprises a plurality of filtration membrane envelopes, which are vertical, parallel, and spaced to one another in a rigid holder, wherein each filter membrane envelope has an end portion covered by a U-shaped cap, characterized in that, said cap is a metal cap, preferably a stainless steel cap.

### FIELD OF THE INVENTION

The present invention relates to a filtration membrane module to be used in water treatment, more particularly water filtration and wastewater purification.

### BACKGROUND

Conventional filter systems for wastewater treatment may consist of a filtration unit with a box-shaped housing, open at the top and bottom, in which multiple membrane envelopes are arranged, vertically and parallel to one another and spaced apart from adjacent membrane envelopes. The spaces between the individual membrane envelopes form passages that are traversable by a fluid. Such a module is known from WO2003037489.

Prolonged usage of membrane modules for treating high turbidity wastewater can result in membrane clogging with suspended components contained in the sludge, and a decrease of the flow rates through the membrane. Therefore, filtration facilities using membrane modules usually perform physical cleaning operations of the membranes by scouring air in between the membranes or, if possible, by backflushing water through the membrane. The sludge buildup weakens the straightness of the membrane envelopes. The loss of straightness results in an uneven spacing of the membrane envelopes, which in return causes more sludge build-up and obstruction of flow. In practice this is overcome by using a comb-like capping structure made of plastic polymers, that is inserted at the top and the bottom of the membrane envelopes. JP5369278 discloses the use of a comb-like spacer for preventing the loss of straightness of membrane envelopes.

However, the comb-like spacers currently available present several disadvantages. Firstly, they do not provide enough straightness to the membranes. Secondly, they do not allow increased packing density of the filter module due to their dimensions. Lastly, the dimension of the U-caps does not provide enough space for effective in and out water transport in submerged operations.

In extreme cases, the combination of U-caps and comb can lead to tear and wear which results in abrasion of the U-Cap or the comb. This has structural implications for the operation.

The present invention aims to resolve at least some of the problems and disadvantages mentioned above.

There remains a need in the art for improved caps that provide sufficient straightness of filtration membrane envelopes and increased packing density. Accordingly, a need arises for the present cap system that provides straightness to the filtration membrane envelopes and allows increased packing density.

### SUMMARY OF THE INVENTION

The present invention and embodiments thereof serve to provide a solution to one or more of the above-mentioned disadvantages. To this end, the present invention relates to a filtration module and a capping system for said filtration module according to claim 1.

The invention thereto aims to provide a capping system for filtration modules that provide sufficient straightness to filtration membrane envelopes and allow increased packing density, while not hindering the water circulation in and out of the filter module. Preferred embodiments of the are shown in any of the claims 2 to 13.

In a second aspect, the present invention relates to the use of the filtration module according to claim 14. Preferred embodiments of the use are shown in any of claims 15 and 16.

### DESCRIPTION OF FIGURES

FIG. 1 shows a cross-section representation of a U-shaped cap, according to an embodiment of the present invention.

FIG. 2 schematically presents a perspective view from above, of a filter module according to an embodiment of the present invention.

FIG. 3 shows a cross-section representation of membrane envelopes with U-caps, according to an embodiment of the present invention.

### DETAILED DESCRIPTION OF THE INVENTION

The present invention concerns a filtration module for water treatment and a capping system thereof. Furthermore, the present invention relates to the use of said filter module.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specify the presence of what follows e.g. component and do not exclude or preclude the presence of additional, non-recited components, features, element, members, steps, known in the art or disclosed therein.

Furthermore, the terms first, second, third, and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The recitation of numerical ranges by endpoints includes all numbers and fractions subsumed within that range, as well as the recited endpoints.

The expression “% by weight”, “weight percent”, “% wt” or “wt %”, here and throughout the description unless otherwise defined, refers to the relative weight of the respective component based on the overall weight of the formulation.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7, etc. of said members, and up to all said members.

The term “packing density” as used herein represents the total surface area of the membrane material (m²) comprised in a module volume (m³).

The term “footprint” as used herein represents the membrane area occupied by the filter module (m²) in a given space (m²).

The term “filtration membrane envelope” as used herein designates a double membrane with an integrated permeate channel consisting of a 3D spacer material with an active membrane skin layer outside of said envelope.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures, or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention and form different embodiments, as would be understood by those in the art. For example, in the following claims, any of the claimed embodiments can be used in any combination.

In a first aspect, the invention relates to a filtration module for the purification and/or filtering of a fluid such as water or wastewater; said module comprises a plurality of filtration membrane envelopes, which are vertical, parallel, and spaced to one another in a rigid holder, wherein each filter membrane envelope has an end portion covered by a U-shaped cap, wherein, said cap is a metal cap, preferably a stainless steel cap. The metal caps are highly durable and are more resistant to the damage produced by vibrations and abrasive materials in the wastewater, compared to the comb-like structures made of plastic polymers, that are usually used.

In a preferred embodiment of the filtration envelope disclosed herein, the cap extends lengthwise along the whole end portion of said filter membrane envelope.

In an embodiment, the metal caps are positioned on the top and the bottom of each membrane envelope. This provides enough straightness to the membrane envelopes, preventing bending of the envelopes and sludge accumulation in between them.

The U-shaped caps of the invention are comprised of a top portion and two legs extending at an angle of between 80 and 110° from said top portion, wherein the distance between the legs is between 1.5 and 10 mm. In an embodiment said distance is between 2 and 10 mm, between 2.5 and 10 mm, between 3 and 10 mm, between 3.5 and 10 mm, between 4 and 10 mm, between 4.5 and 10 mm, between 5 and 10 mm, between 5.5 and 10 mm, between 6 and 10 mm, between 6.5 and 10 mm, between 7 and 10 mm, between 7.5 and 10 mm, between 8 and 10 mm, between 8.5 and 10 mm, between 9 and 10 mm, between 9.5 and 10 mm between 1.5 and 4 mm, between 1.5 and 3.5 mm, between 1.5 and 3 mm, between 1.5 and 2.5 mm, between 1.5 and 2 mm, between 1.5 and 3.5 mm, between 1.5 and 4 mm, between 1.5 and 4.5 mm, between 1.5 and 5 mm, between 1.5 and 5.5 mm, between 1.5 and 6 mm, between 1.5 and 6.5 mm, between 1.5 and 7 mm, between 1.5 and 7.5 mm, between 1.5 and 8 mm, between 3.2 and 3.3 mm, between 3.2 and 3.4 mm, between 3.2 and 3.5 mm, between 3.2 and 3.6 mm, between 3.2 and 3.7 mm, between 3.2 and 3.8 mm, between 3.2 and 3.9 mm, between 3.2 and 4 mm, between 3.3 and 4 mm, between 3.4 and 4 mm, between 3.5 and 4 mm, between 3.6 and 4 mm, between 3.7 and 4 mm, between 3.8 and 4 mm or between 3.9 and 4 mm, preferably between 3.2 and 4 mm. In a further embodiment, the two legs of the cap are extending at an angle between 80 and 100°, between 80 and 90°, between 90 and 110° or between 100 and 110°, preferably around 90°, even more preferably the legs are parallel to each other.

In a further embodiment said U-shaped caps have an overall thickness of between 0.1 and 0.35 mm, between 0.15 and 0.35 mm, between 0.2 and 0.35 mm, between 0.25 and 0.35 mm, between 0.3 and 0.35 mm, between 0.1 and 0.3 mm, between 0.1 and 2.5 mm or between 0.1 and 2 mm, preferably 0.3 mm.

The height of the U-shaped caps is between 3 and 8 mm and the width of said caps is between 1.7 and 10.7 mm. In an embodiment, said height is between 3 and 7.5 mm, between 3 and 7 mm, between 3 and 6.5 mm, between 3 and 6 mm, between 3 and 5.5 mm, between 3 and 5 mm, between 3 and 4.5 mm, between 3 and 4 mm, between 3 and 3.5 mm, between 3.5 and 8 mm, between 4 and 8 mm, between 4.5 and 8 mm, between 5 and 8 mm, between 5.5 and 8 mm, between 6 and 8 mm, between 6.5 and 8 mm, between 7 and 8 mm, between 7.5 and 8 mm, between 4 and 7 mm, between 4.5 and 7 mm, between 5 and 7 mm, between 5.5 and 7 mm, between 6 and 7 mm, between 6.5 and 7 mm, between 4 and 6.5 mm, between 4 and 6 mm, between 4 and 5.5 mm, between 4 and 5 mm or between 4 and 4.5 mm, preferably between 4 and 7 mm. In a further embodiment, the width of the caps is between 1.7 and 10.7 mm, between 1.7 and 10, between 1.7 and 9 mm, between 1.7 and 8 mm, between 1.7 and 7 mm, between 1.7 and 6 mm, between 1.7 and 5 mm, between 1.7 and 4 mm, between 1.7 and 3 mm, between 1.7 and 2 mm, between 2 and 10.7 mm, between 3 and 10.7 mm, between 4 and 10.7 mm, between 5 and 10.7 mm, between 6 and 10.7 mm, between 7 and 10.7 mm, between 8 and 10.7 mm, between 9 and 10.7 mm or between 10 and 10.7, preferably between 3.2 and 4 mm.

By preference, the filter membrane envelopes are positioned at 2 to 10 mm of one another in the filtration module. The positioning of the membranes is dictated by the type of application they are used. In a further embodiment, the filter module is used for wastewater treatment and said membrane envelopes are positioned at a distance between 3 and 10 mm, between 3.5 and 10 mm, between 4 and 10 mm, between 4.5 and 10 mm, between 5 and 10 mm, between 5.5 and 10 mm, between 6 and 10 mm, between 6.5 and 10 mm, between 7 and 10 mm, between 7.5 and 10 mm, between 8 and 10 mm, between 8.5 and 10 mm, between 9 and 10 mm, between 9.5 and 10 mm, between 3 and 9.5 mm, between 3 and 9 mm, between 3 and 8.5 mm, between 3 and 8 mm, between 3 and 7.5 mm, between 3 and 7 mm, between 3 and 6.5 mm, between 3 and 6 mm, between 3 and 5.5 mm, between 3 and 5 mm, between 3 and 4.5 mm, between 3 and 4 mm or between 3 and 3.5 mm, preferably between 3 and 10 mm. In an embodiment, the filter module is used for purification of surface water treatment, and said membrane envelopes are positioned at a distance between 2 and 5 mm, between 2.5 and 5 mm, between 3 and 5 mm, between 3.5 and 5 mm, between 4 and 5 mm, between 4.5 and 5 mm, between 2 and 4.5 mm, between 2 and 4 mm, between 2 and 3.5 mm, between 2 and 3 mm or between 2 and 2.5 mm, preferably between 2 and 5 mm.

The U-shaped caps are positioned at 1.4 to 9.4 mm of one another in the filtration module. In an embodiment, where the filter module is used for wastewater treatment, said caps are positioned at a distance between 2.4 and 9.4 mm, preferably between 3.4 and 8.4 mm, more preferably between 4.4 and 7.4 mm. In an embodiment, where the filter module is used for surface water treatment, said caps are positioned at a distance between 1.4 and 6.4 mm, preferably between 1.4 and 5.4 mm, more preferably between 1.4 and 4.4 mm.

The membrane envelopes of the filtration module have a width between 630 and 690 mm and a length between 1000 and 1060 mm on both sides and the surface of an envelope is between 1.26 and 1.46 m². In a preferred embodiment, the membrane envelopes have a width on both sides between 630 and 690 mm, between 630 and 680 mm, between 630 and 670 mm, between 630 and 660 mm, between 630 and 650 mm, between 630 and 640 mm, between 640 and 690 mm, between 650 and 690 mm, between 660 and 690 mm, between 670 and 690 mm or between 680 and 690 mm, preferably about 660 mm. In a further and preferred embodiment, the membrane envelopes have a length between 1000 and 1060 mm, between 1000 and 1050 mm, between 1000 and 1040 mm, between 1000 and 1030 mm, between 1000 and 1020 mm, between 1000 and 1010 mm, between 1010 and 1060 mm, between 1020 and 1060 mm, between 1030 and 1060 mm, between 1040 and 1060 mm or between 1050 and 1060, preferably about 1030 mm. In a further and preferred embodiment, the surface of an envelope is between 1.26 and 1.46 m², preferably about 1.36 m².

In an embodiment, the membrane envelopes of the filtration module have a width between 630 and 690 mm and a length between 400 and 600 mm, and the surface of an envelope is between 0.5 and 0.83 m2. In a preferred embodiment, the membrane envelopes have a width on both sides between 630 and 690 mm, between 630 and 680 mm, between 630 and 670 mm, between 630 and 660 mm, between 630 and 650 mm, between 630 and 640 mm, between 640 and 690 mm, between 650 and 690 mm, between 660 and 690 mm, between 670 and 690 mm or between 680 and 690 mm, preferably about 660 mm. In a further and preferred embodiment the membrane envelopes have a length between 400 and 600 mm, between 400 and 590 mm, between 400 and 580 mm, between 400 and 570 mm, between 400 and 560 mm, between 400 and 550 mm, between 400 and 540 mm, between 400 and 530 mm, between 400 and 520 mm, between 400 and 510 mm, between 400 and 500 mm, between 400 and 490 mm, between 400 and 480 mm, between 400 and 470 mm, between 400 and 460 mm, between 400 and 450 mm, between 400 and 440 mm, between 400 and 430 mm, between 400 and 420 mm, between 400 and 410 mm, between 410 and 600 mm, between 420 and 600 mm, between 430 and 600 mm, between 440 and 600 mm, between 450 and 600 mm, between 460 and 600 mm, between 470 and 600 mm, between 480 and 600 mm, between 490 and 600 mm, between 500 and 600 mm, between 510 and 600 mm, between 520 and 600 mm, between 530 and 600 mm, between 540 and 600 mm, between 550 and 600 mm, between 560 and 600 mm, between 570 and 600 mm, between 580 and 600 mm, between 590 and 600 mm, between 500 and 560 mm, between 510 and 560 mm, between 520 and 560 mm, between 530 and 560 mm, between 540 and 560 mm, between 550 and 560 mm, preferably about 520 mm. In a further and preferred embodiment, the total envelope surface in a filtration module is between 0.5 and 0.83 m² or between 0.60 and 0.77 m², preferably about 0.69 m². In an embodiment, the module comprises between 50 and 120 filter membrane envelopes. In a further embodiment, the module comprises between 50 and 110 filter membrane envelopes, between 50 and 100 membrane envelopes, between 50 and 90 membrane envelopes, between 50 and 80 membrane envelopes, between 50 and 70 membrane envelopes, between 50 and 60 membrane envelopes, between 50 and 110 membrane envelopes, between 50 and 100 membrane envelopes, between 50 and 90 membrane envelopes, between 50 and 80 membrane envelopes or between 50 and 70 membrane envelopes, preferably between 66 and 107 membrane envelopes.

The filtration module according to any of the above embodiments, has an outer width between 686 and 746 mm and an outer length between 706 and 766. In a preferred embodiment, the outer width of the filtration module is between 686 and 746 mm, between 686 and 736 mm, between 686 and 726 mm, between 686 and 716 mm, between 696 and 746 mm, between 706 and 746 mm, or between 716 and 746 mm, more preferably about 716 mm. In a further preferred embodiment, the outer length of the filtration module is between 706 and 766 mm, between 706 and 756 mm, between 706 and 746 mm, between 706 and 736 mm, between 716 and 766 mm, between 726 and 766 mm or between 736 and 766 mm, preferably about 736 mm. In a further and preferred embodiment, the footprint of the module is between 0.48 and 0.57 m², preferably about 0.53 m².

In an embodiment, the packing density of the filtration module is between 120 and 290 m⁻¹ membrane. In a preferred embodiment, said packing density is between 110and 311 m⁻¹ membrane, between 110 and 290 m⁻¹ membrane, between 110 and 270m 1 membrane, between 110 and 250 m⁻¹ membrane, between 110 and 230 m⁻¹ membrane, between 110 and 210 m⁻¹ membrane, between 110 and 190 m⁻¹ membrane, between 110 and 170 m⁻¹ membrane, between 110 and 150 m⁻¹ membrane, between 110 and 130 m⁻¹ membrane, between 130 and 311 m⁻¹ membrane, between 150 and 311 m⁻¹ membrane, between 170 and 311 m⁻¹ membrane, between 190 and 311 m⁻¹ membrane, between 210 and 311 m⁻¹ membrane, between 230 and 311 m⁻¹ membrane, between 250 and 311 m⁻¹ membrane, between 270 and 311 m⁻¹ membrane, between 290 and 311 m⁻¹ membrane, between 120 and 280 m⁻¹ membrane, between 120 and 270 m⁻¹ membrane, between 120 and 260 m⁻¹ membrane, between 120 and 250 m⁻¹ membrane, between 120 and 240 m⁻¹ membrane, between 120 and 230 m⁻¹ membrane, between 120 and 220 m⁻¹ membrane, between 120 and 210 m⁻¹ membrane, between 120 and 200 m⁻¹ membrane, between 120 and 190 m⁻¹ membrane, between 120 and 180 m⁻¹ membrane, between 120 and 170 m⁻¹ membrane, between 120 and 160 m⁻¹ membrane, between 120 and 150 m⁻¹ membrane, between 120 and 140 m⁻¹ membrane, between 120 and 130 m⁻¹ membrane, between 130 and 290 m⁻¹ membrane, between 140 and 290 m⁻¹ membrane, between 150 and 290 m⁻¹ membrane, between 160 and 290 m⁻¹ membrane, between 170 and 290 m⁻¹ membrane, between 180 and 290 m⁻¹ membrane, between 190 and 290 m⁻¹ membrane, between 200 and 290 m⁻¹ membrane, between 210 and 290 m⁻¹ membrane, between 220 and 290 m⁻¹ membrane, between 230 and 290 m⁻¹ membrane, between 240 and 290 m⁻¹ membrane, between 250 and 290 m⁻¹ membrane, between 260 and 290 m⁻¹ membrane, between 270 and 290 m⁻¹ membrane or between 280 and 290 m⁻¹ membrane, preferably between 120 and 290 m⁻¹ membrane.

In another embodiment, multiple modules of the same size are stacked forming double, triple, quadruple, or quintuple deck systems. Furthermore, multiple modules with different sizes are stacked forming, one and a half, two and a half, three and a half or four and a half deck systems.

The membrane envelopes of the filtration module comprise a 3D spacer fabric interposed between two membrane layers.

Said 3D spacer fabric has an upper and a lower fabric surface, tied together and spaced apart by monofilament threads at a predefined distance, said permeate channel being interposed between two membrane layers, wherein said membrane layers are linked at a multitude of points with said upper and lower fabric surfaces. The fabric surfaces and the monofilaments of the 3D spacer fabric are linked by loops in the monofilament threads. Said loops are embedded in said membrane layers. Preferably, the fabric surfaces are of a knitted, woven, or non-woven type, preferably a knitted fabric. The distance between the upper and lower fabric surface preferably lies between 0.5 and 10 mm.

In an embodiment, the 3D spacer preferably comprises a material selected from the group consisting of polyester, nylon, polyamide, polyphenylene sulphide, polyethylene, and polypropylene. The membrane layer preferably comprises a hydrophilic filler material selected from the group consisting of HPC, CMC, PVP, PVPP, PVA, PVAc, PEO TiO2, HfO2, Al2O3, ZrO2, Zr3(PO4)4, Y2O3, SiO2, perovskite oxide materials, SiC; and an organic binder material selected from the group consisting of PVC, C-PVC, PSF, PESU, PPS, PU, PVDF, PI, PAN, and their grafted variants.

In a particular embodiment of the present invention, said membrane is planar. The membrane preferably further comprises a sealant at the perimeter of the planar membrane arranged to prevent direct fluid movement from or to the permeate channel without passing through a membrane layer, and an inlet/outlet port connection(s) in fluid connection with the permeate channel, provided at least one edge on the perimeter.

In a second aspect, the invention relates to the use of a filtration module according to the description above, for the purification and/or filtering of a fluid such as water or wastewater. The filtration module can be used for filtration and/or purification of surface water or of wastewater. However, it is obvious that the invention is not limited to this application. The filtration module and the U-shaped caps according to the invention can be applied in treating all sorts of liquid feed sources.

The inventors have observed that attaching the metal U-caps on the membrane envelopes of the filtration module, provides straightness to the membrane envelopes, preventing them from bending. As such the filtration modules can be used longer and due to their minimal design allow higher packing densities and thus improved filtration capacity. The U-caps are made of durable materials which allow for prolonged use of the filter module, without damage or decrease in the filtration performance.

By preference, the filtration module used for purification and/or filtering of water can be backwashed at a pressure of at least 100 mbar. In an embodiment, said filtration module can be backwashed at a pressure of at least 100 mbar, more preferably at least 110 mbar, more preferably at least 120 mbar, more preferably at least 130 mbar, more preferably at least 140 mbar, more preferably at least 150 bar, more preferably at least 160 bar, more preferably at least 170 bar, more preferably at least 180 mbar, more preferably at least 190 mbar, more preferably at least 200 mbar, more preferably at least 210 mbar, more preferably at least 220 mbar, more preferably at least 230 mbar, more preferably at least 240 mbar, more preferably at least 250, more preferably at least 260 mbar, more preferably at least 270 mbar, more preferably at least 280 mbar, more preferably at least 290 mbar, more preferably at least 300 mbar, more preferably at least 350 mbar, more preferably at least 400 mbar. This high-pressure back pulse is possible without losing the mechanical cleaning efficiency of the backwashing. During this operation, the membranes and more specifically the pores present are cleaned from any debris that was filtered out of the water. This may also include chemically enhanced backwash cleaning, wherein the pores are chemically cleaned by means of a volumetric flow of chemicals over the whole membrane envelope. As for any operation, this again requires an optimal and even flow.

The invention is further described by the following non-limiting examples which further illustrate the invention, and are not intended to, nor should they be interpreted to, limit the scope of the invention.

### DESCRIPTION OF FIGURES

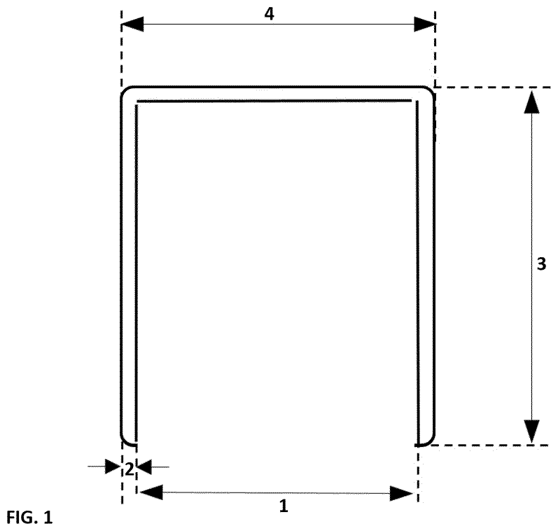

With reference to FIG. 1, a cross-section of a U-shaped cap, according to an embodiment of the current invention, is shown. Said cap has a distance between the legs (1), a wall thickness (2), a height (3), and a width (4). As an example, said cap may be 0.3 mm thick and may have a distance of between 3.2 and 4 mm between the legs, between 4 and 7 mm height, and between 3.8 and 4.6 mm width.

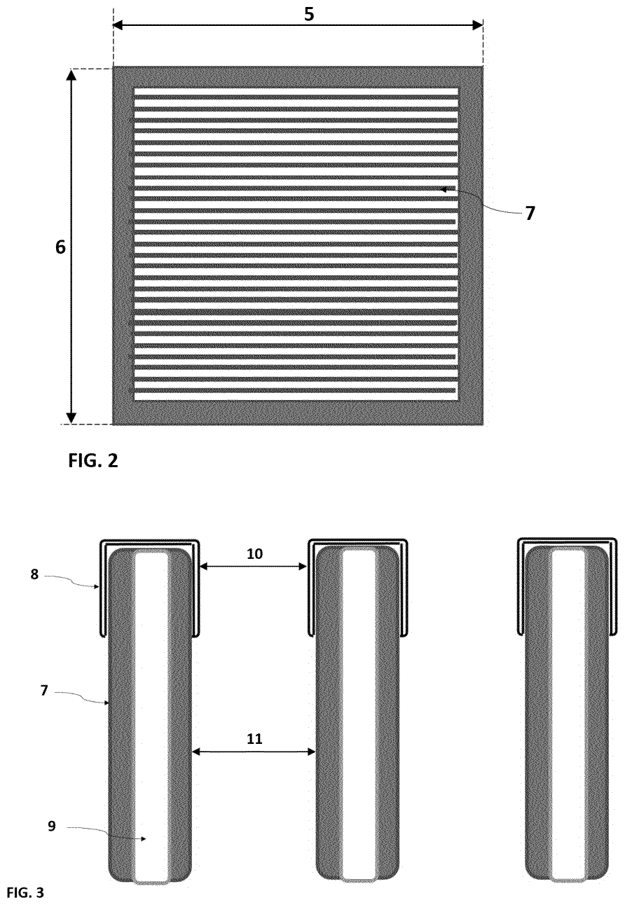

With reference to FIG. 2, an above view of a filter module, according to an embodiment of the current invention, is shown. Said filter module has an outer width (5) and an outer length (6) and membrane envelopes (7) where the filtrate is evacuated from the module. As an example, said filter module may have an outer width of 716 mm, an outer length of 736 mm, and may contain between 66 and 107 membrane envelopes.

With reference to FIG. 3, a cross-section of membrane envelopes with U-shaped caps is shown. Said caps (8) are positioned at a distance (10) from one another and said membrane envelopes (7) are positioned at a distance (11) from one another. The membrane envelopes (7) comprise a 3D spacer fabric (9) interposed between two membrane layers.

Each cap extends lengthwise along the whole end portion of said filter membrane envelope.

The present invention is in no way limited to the embodiments described in the examples and/or shown in the figures. On the contrary, methods according to the present invention may be realized in many different ways without departing from the scope of the invention.

### LIST OF INDICATED ELEMENTS

1 distance between the legs of the cap
2 wall thickness
3 height of the cap
4 width of the cap
5 outer width of the filter module
6 outer length of the filter module
7 membrane envelopes
8 caps
9 3D spacer fabric
10 distance between the caps
11 distance between the membrane envelopes

1. A filtration module for the purification and/or filtering of a fluid such as water or wastewater; said module comprising:
a plurality of filtration membrane envelopes, which are vertical, parallel, and spaced to one another in a rigid holder, wherein each of said filter membrane envelopes has an end portion covered by a U-shaped cap, characterized in that, said U-shaped cap is a metal cap.

2. The filtration module according to claim 1, characterized in that one of the metal caps extends lengthwise along the whole end portion of each of said filter membrane envelopes.

3. The filtration module according to claim 1, characterized in that one of the metal caps is positioned on a top and a bottom of each of said membrane envelopes.

4. The filtration module according to claim 1, characterized in that, the U-shaped cap is comprised of a top portion and two legs extending at an angle of between 80 and 110° from said top portion, wherein a distance between the legs is between 1.5 and 10 mm.

5. The filtration module according to claim 1, characterized in that, the U-shaped cap has an overall wall thickness of between 0.1 and 0.35 mm.

6. The filtration module according to claim 1, characterized in that, a height of the U-shaped cap is between 3 and 8 mm and a width is between 1.7 and 10.7 mm.

7. The filtration module according to claim 1, characterized in that, the filtration membrane envelopes are positioned at 2 to 10 mm of one another in said holder.

8. The filtration module according to claim 1, characterized in that, the filtration membrane envelopes have a width between 630 and 690 mm and a length between 1000 and 1060 mm and a surface of each of the filtration membrane envelopes is between 1.26 and 1.46 m².

9. The filtration module according to claim 1, characterized in that, the filtration membrane envelopes have a width between 630 and 690 mm and a length between 400 and 600 mm and a surface of each of the filtration envelopes is between 0.50 and 0.83 m².

10. The filtration module according to claim 1, characterized in that, the module comprises between 50 and 120 of the filtration membrane envelopes.

11. The filtration module according to claim 1, characterized in that, the module has an outer width (5) between 686 and 746 mm and an outer length (6) between 706 and 766 mm.

12. The filtration module according to claim 1, characterized in that, a packing density of the module is between 120 and 290 m⁻¹ membrane.

13. The filtration module according to claim 1, characterized in that, a plurality of the modules of a same size are stacked forming double, triple, quadruple, or quintuple deck systems.

14. The filtration module according to claim 1, wherein said filtration membrane envelopes comprise a 3D spacer fabric interposed between two membrane layers.

15. Use of the filtration module according to claim 1 for the purification and/or filtering of liquids.

16. The use according to claim 15, wherein said filtration module is backwashed at a pressure of at least 100 mbar.

17. The filtration module according to claim 1, wherein said U-shaped cap is a stainless steel cap.

18. The use according to claim 15, wherein the liquids include water or wastewater.
